(19) United States
(12) Patent Application Publication
(10) Pub. No.: US 2025/0334681 A1
(43) Pub. Date: Oct. 30, 2025

(54) ECHO DATA PROCESSING METHOD AND DEVICE, TERMINAL DEVICE, AND STORAGE MEDIUM

(71) Applicant: SUTENG INNOVATION TECHNOLOGY CO., LTD., Shenzhen (CN)

(72) Inventor: Yan ZHAO, Shenzhen (CN)

(73) Assignee: SUTENG INNOVATION TECHNOLOGY CO., LTD., Shenzhen (CN)

(21) Appl. No.: 19/185,184

(22) Filed: Apr. 21, 2025

(30) Foreign Application Priority Data
Apr. 28, 2024 (CN) 202410527162.4

(51) Int. Cl. G01S 7/487; G01S 17/10

(52) U.S. Cl. CPC G01S 7/487; G01S 17/10

(57) ABSTRACT

The present application provides an echo data processing method, a device, a terminal equipment, and a storage medium. The echo data processing method includes: obtaining echo data corresponding to a plurality of scans, and determining echo features according to the echo data; determining target echo data according to the echo features of a current scan and the echo features of a last scan, the target echo data being echo data after high-reflection-expansion echo is filtered out; and fusing the target echo data to perform target recognition according to the fused target echo data.

### CROSS-REFERENCE TO RELATED APPLICATION

The present application claims the benefit of priority to Chinese Patent Application No. 202410527162.4, filed on Apr. 28, 2024, which is hereby incorporated by reference in its entirety.

### TECHNICAL FIELD

The present application relates to the technical field of LiDAR, and in particular to an echo data processing method and device, a terminal device, and a storage medium.

### BACKGROUND

LiDAR is a radar system for detecting the position, speed, and other information of a target by emitting a laser beam. In addition to detecting the distance of an object, the LiDAR can also detect the reflectivity of the object for target recognition. The specific working principle of the LiDAR is to emit a detection signal to a target. After the detection signal reaches the target, it is reflected by the target object to form echo data. The LiDAR receives the signal (echo data) reflected by the target, and then determines the relevant information of the target according to the echo data, such as the target distance, position, height, speed, attitude, shape, reflectivity, and the like, thereby achieving target detection, target tracking, and target recognition.

When the LiDAR detects a high-reflectivity object, point cloud expansion occurs, because the energy reflected by the high-reflectivity object is larger than 100 times the energy reflected by a normal-reflectivity object, resulting in diffusion or expansion of the point cloud data when generated, thereby affecting the object recognition capability of the LiDAR.

### SUMMARY

Embodiments of the present application provide an echo data processing method and device, a terminal device, and a storage medium, which are configured to effectively filter the point cloud corresponding to the point cloud expansion, thereby reducing the influence of the point cloud expansion on the object recognition capability of the LiDAR and improving the object recognition accuracy of the LiDAR.

In a first aspect, the embodiment of the present application provides an echo data processing method, including: acquiring echo data corresponding to multiple scans, and determining echo features according to the echo data; determining target echo data according to the echo features of the current scan and the echo features of the last scan, where the target echo data is echo data after high-reflectivity expansion echo is filtered out; and fusing the target echo data to perform target recognition according to the fused target echo data.

In an implementation of the first aspect, the echo features include echo areas, and the determination of the target echo data according to the echo features of the current scan and the echo features of the last scan includes: if there is high-reflectivity expansion echo in the echo of the current scan or the echo of the last scan; and the echo data corresponding to the scan with a small echo area is determined as the target echo data; if there is no high-reflectivity expansion echo in the echo of the current scan or the echo of the last scan; and the echo data corresponding to the scan with a large echo area is determined as the target echo data; If an absolute value difference between the echo area of the current scan and the echo area of the previous scan is less than a preset area difference threshold, or an absolute value difference between the distance value corresponding to the echo of the current scan and the distance value corresponding to the echo of the previous scan is less than a distance difference threshold, the mean value of the echo data of the current scan and the echo data of the previous scan is used as the target echo data.

In an implementation of the first aspect, the echo feature includes a transmission power, and the determining the target echo data according to the echo feature of the current scan and the echo feature of the previous scan includes: if there is a high-reflection echo in the echo of the current scan or the echo of the previous scan, the echo data corresponding to the scan with the smaller transmission power is determined as the target echo data; if an absolute value difference between the transmission power of the current scan and the transmission power of the previous scan is less than a preset power difference threshold, or an absolute value difference between the distance value corresponding to the echo of the current scan and the distance value corresponding to the echo of the previous scan is less than a distance difference threshold, the mean value of the echo data of the current scan and the echo data of the previous scan is used as the target echo data.

In an implementation of the first aspect, before the determining the target echo data according to the echo feature of the current scan and the echo feature of the previous scan, the method further includes: determining, according to the detection result, an echo peak value and an echo width of each echo; If the echo peak value of the echo is greater than or equal to a peak threshold and the echo width of the echo is greater than or equal to a width threshold, the echo is determined as the echo corresponding to the high-reflectivity object; filtering, from the echo data, the echo data corresponding to the high-reflectivity object to obtain detection-filtered echo data.

In an implementation of the first aspect, after the determining, according to the detection result, the echo peak value and the echo width of each echo, the method further includes: determining a peak threshold and a width threshold of a time interval in which the echo is located, where different time intervals are set with different peak thresholds and width thresholds. If the echo peak value of the echo is greater than or equal to the peak threshold corresponding to the time interval in which the echo is located and the echo width of the echo is greater than or equal to the width threshold corresponding to the time interval in which the echo is located, the echo is determined as the echo corresponding to the high-reflectivity object.

In an implementation of the first aspect, the echo data is echo data received after the LiDAR performs transceiving control based on a preset scanning mode. The preset scanning mode is a scanning mode in which a laser emitter of the LiDAR transmits detection signals block by block and a group of receiving units corresponding to a transmission block receives echo signals, and the group of receiving units includes at least two receiving units.

In an implementation of the first aspect, before the target echo data is determined according to the echo feature of the current scan and the echo feature of the last scan, the method further includes: performing high reflection filtering on the echo data according to the valid data interval.

In an implementation of the first aspect, performing high reflection filtering on the echo data according to the valid data interval includes: determining, from the valid reception interval table, a reception pixel range of the valid reception interval according to the distance value corresponding to the echo and the emission block position of the LiDAR; if the reception range of the echo exceeds the reception pixel range of the valid reception interval, outputting echo data corresponding to the valid reception interval; and if the reception range of the echo is within the reception pixel range of the valid reception interval, outputting all the echo data.

In a second aspect, an embodiment of the present application provides an echo data processing apparatus, including: an acquisition unit, configured to acquire echo data corresponding to multiple scans, and determine an echo feature according to the echo data; a determination unit, configured to determine target echo data according to the echo feature of the current scan and the echo feature of the last scan, the target echo data being echo data after high reflection expansion echo is filtered out; and a fusion unit, configured to fuse the target echo data, so as to perform target recognition according to the fused target echo data.

In a third aspect, an embodiment of the present application provides a terminal device, the terminal device including a processor, a memory, and a computer program stored in the memory and executable on the processor, the processor implementing the method of the first aspect or any optional implementation of the first aspect when executing the computer program.

In a fourth aspect, an embodiment of the present application provides a computer-readable storage medium, the computer-readable storage medium storing a computer program, the computer program implementing the method of the first aspect or any optional implementation of the first aspect when executed by a processor.

In a fifth aspect, an embodiment of the present application provides a computer program product, which, when running on a terminal device, enables the terminal device to perform the method of the first aspect or any optional implementation of the first aspect.

Compared with the prior art, the echo data processing method and apparatus, the terminal device, and the computer-readable storage medium provided by the embodiment of the present application can filter out the high reflection expansion echo corresponding to the high reflection object in the data fusion process, effectively filter out the point cloud corresponding to the point cloud expansion, thereby reducing the influence of the point cloud expansion on the object recognition capability of the LiDAR, and improving the object recognition accuracy of the LiDAR.

### BRIEF DESCRIPTION OF DRAWINGS

In order to more clearly illustrate the embodiments of the present application or the technical solutions in the prior art, the drawings are briefly introduced below. Obviously, the drawings described below are only some embodiments of the present application. For ordinary technicians in this field, other drawings can be obtained based on these drawings without any creative work.

FIG. 1 is a schematic diagram of the partial structure of a LiDAR provided by some embodiments of the present application;

FIG. 2 is a schematic diagram of point cloud expansion when a LiDAR detects a high reflectivity object;

FIG. 3 is a schematic diagram of an implementation process of an echo data processing method provided by some embodiments of the present application;

FIG. 4 is a schematic diagram of a specific implementation process of S12 in the method provided by some embodiments of the present application;

FIG. 5 is a schematic diagram of a structure of another LiDAR provided by some embodiments of the present application;

FIG. 6 is a schematic diagram of a comparison of an echo waveform corresponding to a high reflectivity object and an echo waveform corresponding to a non-high reflectivity object;

FIG. 7 is a schematic diagram of a process of filtering an echo waveform corresponding to a high reflectivity object in the method provided by some embodiments of the present application;

FIG. 8 is a schematic diagram of a correspondence relationship of a transmitting module and a receiving module of a LiDAR provided by some embodiments of the present application;

FIG. 9 is a schematic diagram of a process of limit filtering in the method provided by some embodiments of the present application;

FIG. 10 is a distribution of point cloud data after processing by the echo data processing method provided by some embodiments of the present application;

FIG. 11 is a schematic diagram of a structure of an echo data processing apparatus provided by some embodiments of the present application;

FIG. 12 is a schematic diagram of a structure of an echo data processing apparatus provided by some embodiments of the present application; and

FIG. 13 is a schematic diagram of a structure of an echo data processing apparatus provided by some embodiments of the present application.

### DETAILED DESCRIPTION

In the following description, for purposes of explanation and not limitation, specific details are set forth, such as particular architectures, techniques, etc., in order to provide a thorough understanding of the present application. However, it will be apparent to those skilled in the art that the present application can be practiced in other embodiments that depart from these specific details. In other instances, detailed descriptions of well-known systems, devices, circuits, and methods are omitted so as not to obscure the description of the present application with unnecessary detail.

It should be understood that the term “and/or” used in the present application specification and the appended claims refers to any combination of one or more of the associated listed items and all possible combinations, and includes these combinations. In addition, in the description of the present application specification and the appended claims, the terms “first,” “second,” “third,” and the like are only used to distinguish the description, and cannot be understood as indicating or implying relative importance.

It is to be understood that the phrase “one embodiment” or “some embodiments” or the like appearing herein in reference to the present application is intended to refer to one or more embodiments of the present application that include certain features, structures, or characteristics described in connection with that embodiment. Thus, the appearances of the phrase “in one embodiment” or “in some embodiments” or “in other embodiments” or “in yet some embodiments” or the like in various places throughout the specification are not necessarily referring to the same embodiment, although they can. Furthermore, the term “comprising,” “including,” “containing,” and similar terms are intended to be open-ended, unless otherwise noted, so that for example, a structure described as “comprising” a certain feature can also comprise additional features that are not listed.

A LIDAR is a radar system for detecting the position, speed, and other information of a target by emitting a laser beam. In addition to detecting the distance of an object, the LiDAR can also detect the reflectivity of the object for target recognition. The specific working principle of the LiDAR is to emit a detection signal to a target. After the detection signal reaches the target, it is reflected by the target object to form echo data. The LiDAR receives the signal (echo data) reflected by the target, and then determines the relevant information of the target, such as the target distance, position, height, speed, attitude, shape, reflectivity, and the like, according to the echo data, thereby achieving target detection, target tracking, and target recognition. The reflectivity of an object refers to the percentage of the radiant energy reflected by the object to the total radiant energy of the incident signal. The reflectivity of different objects is different, and the reflectivity of an object is mainly determined by the surface properties of the object, the wavelength of the incident signal, the incident angle, and the like.

In specific applications, LiDARs can be categorized based on ranging methods, such as the time of flight (ToF) ranging method, the frequency modulated continuous wave (FMCW) ranging method, and the triangulation ranging method. The time of flight (ToF) ranging method refers to a method in which a set of infrared light (or laser pulses) invisible to the human eye is emitted outward, reflected after encountering an object, and reflected to the end of the radar, and the time difference or phase difference from the emission to the reflection to the radar is calculated to determine the distance of the object.

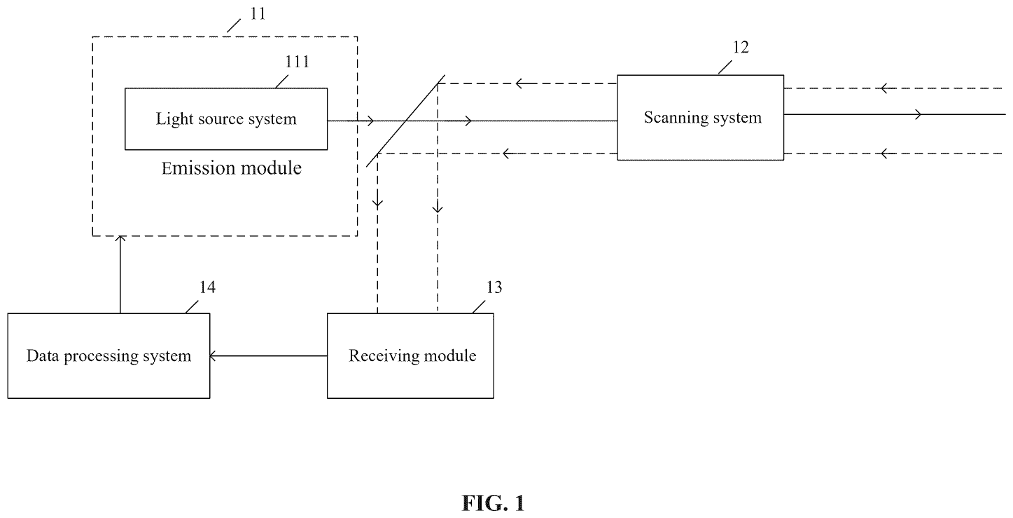

For example, referring to FIG. 1, which shows a schematic diagram of a structure of a LiDAR, the LiDAR 10 generally includes an emission module 11, a scanning system 12, a receiving module 13, and a data processing system 14. The emission module 11 can include a light source system 111.

The light source system 111 is configured to generate a laser beam required for the LiDAR 10 to perform detection. In some embodiments, the light source system 111 can include a laser and an emission lens group and the like. The scanning system 12 is configured to perform angular deflection on the laser beam generated by the light source system 111, so that the laser beam can hit different positions at different moments. The scanning system 12 can be a mechanical scanning system (i.e., a rotating driving platform), or a semi-solid scanning system (i.e., a rotating mirror, a vibrating mirror, or a combination of the two), and the present application does not limit the form of the scanning system. It should be understood that the LiDAR in the present application can also be a solid-state LiDAR, that is, scanning is achieved by controlling light sources at different angles to emit light in sequence. The scanning manner of the LiDAR 10 can be a line scanning manner, or a block scanning manner. The line scanning manner refers to a scanning manner in which a single emission block in the emission module emits, and a whole row of receiving blocks in the receiving module receives. The one-to-one block scanning manner refers to a scanning manner in which a single emission block in the emission module emits, and a corresponding single receiving block in the receiving module receives.

The laser beam emitted by the light source system reaches the target object, is reflected by the target object, and the reflected light pulse is received by a receiving sensor 131 in the receiving module 13, and then the echo signal processing circuit processes the echo signal to generate corresponding detection information.

It should be noted that the light source system can use a vertical cavity surface emitting laser (VCSEL) or an edge emitting laser (EEL) and the like, and the sensor can be composed of a Single Photon Avalanche Diode (SPAD) array or a Silicon photomultiplier (SiPM). The SiPM is composed of a large number (generally including several hundred to several thousand) of SPAD units, each SPAD unit is composed of a SPAD and a large resistance quenching resistor in series, and the SPAD units are connected in parallel to form a surface array (i.e., the SiPM). When the LiDAR detects a high-reflectivity object, point cloud expansion may occur. This is because the energy reflected by a high-reflectivity object can be more than 100 times greater than that reflected by a normal-reflectivity object. As a result, the generated point cloud data appears diffused or expanded, thereby adversely affecting the object recognition capability of the LiDAR.

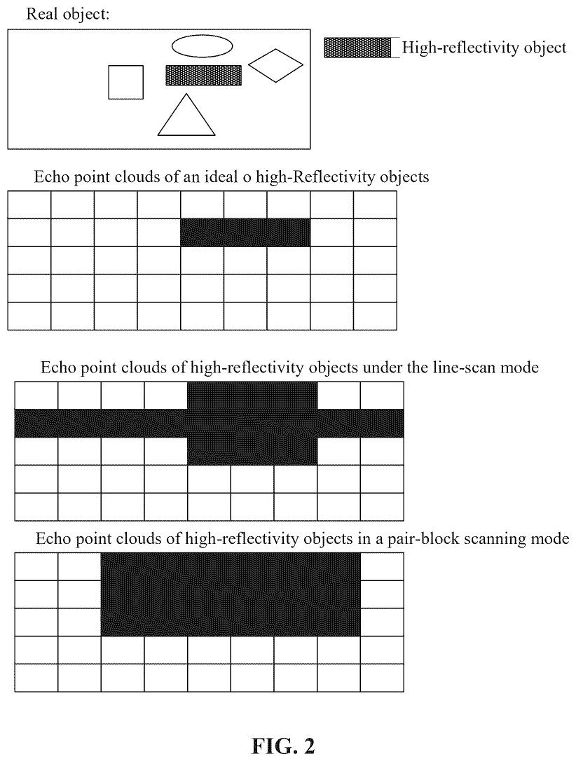

For example, referring to FIG. 2, which shows a schematic diagram of point cloud expansion when the LiDAR detects a high-reflectivity object, the point cloud expansion causes objects around the high-reflectivity object to be covered, so that the objects around the high-reflectivity object cannot be recognized, and the point cloud expansion affects the object recognition capability of the LiDAR.

Based on the above, an embodiment of the present application provides an echo data processing method, which filters high-reflection expansion data from echo data obtained through multiple scans, and subsequently performs data fusion, thereby reducing the influence of point cloud expansion on the object recognition capability of the LiDAR and improving the object recognition accuracy of the LiDAR.

The echo data processing method provided by the present application will be described in detail below.

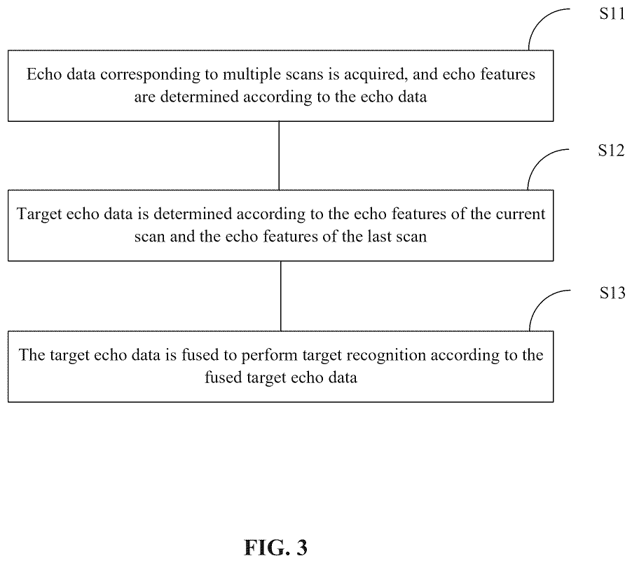

Referring to FIG. 3, which shows an implementation flow of an echo data processing method provided by some embodiments of the present application, the echo data processing method can include S11-S12.

It should be noted that the execution subject of the echo data processing method provided by the present application can be the LiDAR 10, and can be a data processing system in the LiDAR 10. Of course, the execution subject of the echo data processing method can also be a terminal device in communication connection with the LiDAR 10. The terminal device can be a mobile phone, a desktop computer, a notebook computer, a tablet computer, a wearable device, or the like, and can also be a cloud server, a radar-assisted computer, or the like in various scenarios. The present application does not make a specific limitation in this regard. The following takes the LiDAR 10 as an example for description.

In S11, echo data corresponding to multiple scans is acquired, and echo features are determined according to the echo data.

The echo data is echo data obtained by the LiDAR based on multiple scans.

In a specific application, the LiDAR can perform multiple scans on a target, and then fuse the echo data obtained through those multiple scans to perform target recognition according to the fused echo data.

In a specific application, the echo features can include but are not limited to an echo peak value, an echo width, a receiving pixel range, a distance value corresponding to the echo, an echo area, and the like.

In S12, target echo data is determined according to the echo features of the current scan and the echo features of the last scan.

In a specific application, the target echo data is echo data after high-reflection expansion echo is filtered. It can be understood that the target echo data is echo data used for data fusion.

In a specific application, the LiDAR can filter echo data corresponding to high-reflection expansion echo according to echo features corresponding to echo of multiple scans before data fusion.

In an implementation, the LiDAR can determine whether high-reflection expansion echo exists in echoes of two scans. If high-reflection expansion echo exists, echo data corresponding to a scan with a small echo area is selected as target echo data. If high-reflection expansion echo does not exist, echo data corresponding to a scan with a large echo area is selected as target echo data. If the area difference and the distance difference between the two scans are small, the mean value of the echo data corresponding to the two scans can be used as the target echo data.

In another implementation, for the single-point scanning mode, the LiDAR can determine whether there is a high-reflection expansion echo in the echoes of the two scans. If there is, the echo data corresponding to the scan with the smaller transmission power is selected as the target echo data. If there is not, the echo data corresponding to the scan with the larger transmission power is selected as the target echo data. If the absolute value difference between the transmission power of the current scan and the transmission power of the previous scan is less than a preset power difference threshold, or the absolute value difference between the distance value corresponding to the echo of the current scan and the distance value corresponding to the echo of the previous scan is less than a distance difference threshold, the mean value of the echo data of the current scan and the echo data of the previous scan is determined as the target echo data.

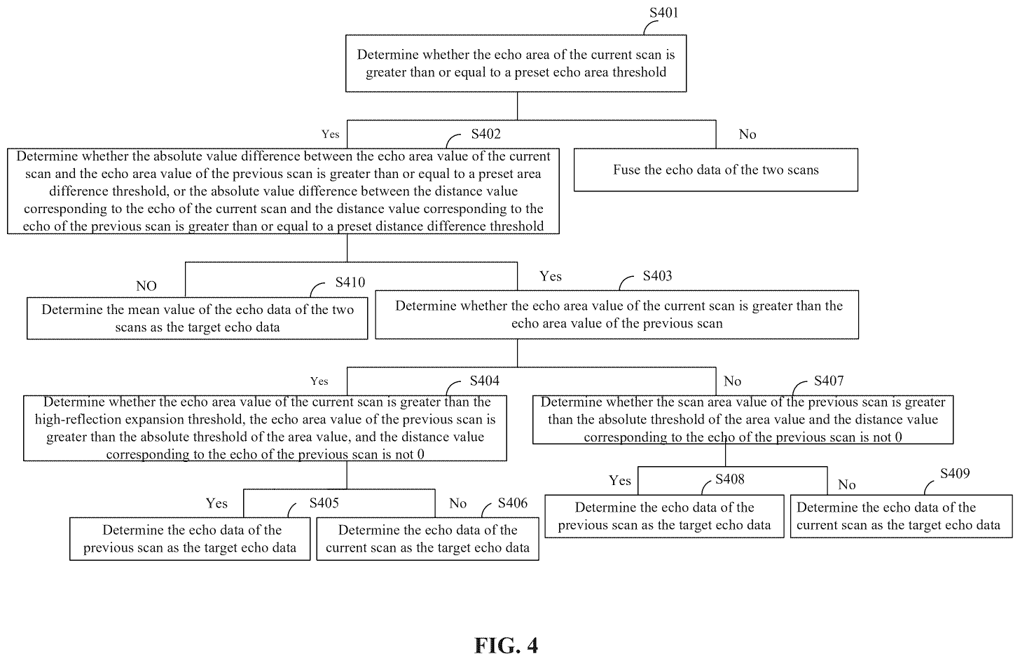

In some embodiments of the present application, as shown in FIG. 4, S12 can include the following steps:
S401: Determine whether the echo area of the current scan is greater than or equal to a preset echo area threshold. If yes, perform S402, otherwise fuse the echo data of the two scans.
S402: Determine whether the absolute value difference between the echo area value of the current scan and the echo area value of the previous scan is greater than or equal to a preset area difference threshold, or the absolute value difference between the distance value corresponding to the echo of the current scan and the distance value corresponding to the echo of the previous scan is greater than or equal to a preset distance difference threshold. If yes, perform S403, otherwise perform S410.

In specific applications, the distance value corresponding to the echo can be determined by the echo width or the echo time.
S403: Determine whether the echo area value of the current scan is greater than the echo area value of the previous scan. If yes, perform S404, otherwise perform S407.
S404: Determine whether the echo area value of the current scan is greater than the high-reflection expansion threshold, the echo area value of the previous scan is greater than the absolute threshold of the area value, and the distance value corresponding to the echo of the previous scan is not 0. If yes, perform S405, otherwise perform S406.
S405: Determine the echo data of the previous scan as the target echo data.
S406: Determine the echo data of the current scan as the target echo data.
S407: Determine whether the scan area value of the previous scan is greater than the absolute threshold of the area value and the distance value corresponding to the echo of the previous scan is not 0. If yes, perform S408, otherwise perform S409.
S408: Determine the echo data of the previous scan as the target echo data.
S409: Determine the echo data of the current scan as the target echo data.
S410: Determine the mean value of the echo data of the two scans as the target echo data.

In S13, the target echo data is fused to perform target recognition according to the fused target echo data.

In a specific application, after the target echo data is determined, the LiDAR can fuse the echo data from which the high reflection expansion echo is filtered. In some embodiments, the target echo data determined based on the first two scans can be fused with the target echo data determined based on the second two scans to obtain a first fusion result. The first fusion result can be fused with the target echo data determined based on the third two scans to obtain a fusion result of the first fusion result and the target echo data determined based on the third two scans (i.e., a second fusion result). In this way, the target echo data determined based on the last two scans can be fused to obtain a total fusion result. Of course, the echo data can be fused in a parallel manner, that is, after all the target echo data is determined, all the target echo data is fused. Of course, the echo data can also be fused in a combination of serial and parallel manners, that is, the target echo data determined based on the first two scans is fused with the target echo data determined based on the second two scans to obtain a first fusion result. The target echo data determined based on the third two scans is fused with the target echo data determined based on the fourth two scans to obtain a second fusion result. In this way, the first fusion result and the second fusion result are fused, and in this way, until all the target echo data is fused.

According to the fusion result, echo waveform recovery can be performed to determine the distance, appearance parameters, and other information of the target object, so that target recognition can be achieved. This part can refer to an existing echo waveform recovery method and a distance determination algorithm, and will not be described herein.

As can be seen from the above, the echo data processing method provided by the embodiment of the present application can filter the high reflection expansion echo corresponding to the high reflection object before data fusion, effectively filter the point cloud corresponding to the point cloud expansion, thereby reducing the influence of the point cloud expansion on the object recognition capability of the LiDAR, and improving the object recognition accuracy of the LiDAR.

In an embodiment of the present application, the echo data processing method can further include the following steps before S12: determining, according to the detection result, an echo peak value and an echo width of each echo; if the echo peak value of the echo is greater than or equal to the peak threshold value and the echo width of the echo is greater than or equal to the width threshold value, determining that the echo is an echo corresponding to a high reflection object; and filtering, from the echo data, echo data corresponding to the high reflection object to obtain detection-filtered echo data.

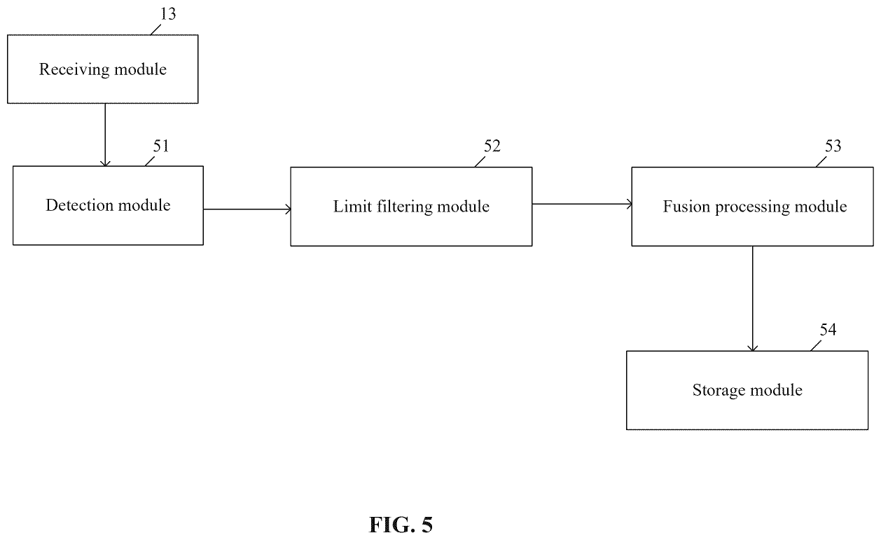

As shown in FIG. 5, the LiDAR can include a detection module 51, a limit filtering module 52, a fusion processing module 53, and a storage module 54.

The detection module 51 is configured to detect an echo waveform from the echo data and determine echo characteristics such as an echo peak value and an echo width.

Each echo represents a different object, and the echo peak value and echo width corresponding to each echo can be obtained by the detection module 51.

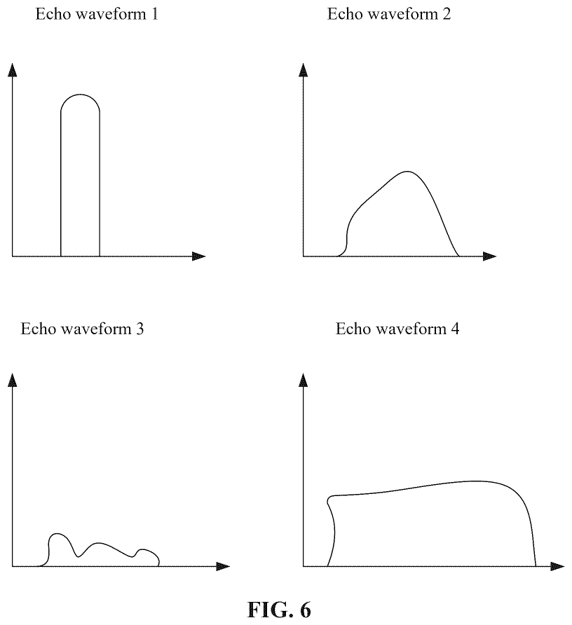

Referring to FIG. 6, which shows a comparison diagram of an echo waveform corresponding to a high reflectivity object and an echo waveform corresponding to a non-high reflectivity object. In FIG. 6, echo 1, echo 2, and echo 3 are echo waveforms corresponding to non-high reflectivity objects, and echo 4 is an echo corresponding to a high reflectivity object. As shown in FIG. 6, the echo width corresponding to the high reflectivity object is larger, and the echo peak value is higher.

After the detection module 51 detects the echo waveform, the LiDAR can perform high-reflection filtering on the echo data according to the echo peak value and echo width of the detected echo waveform, that is, filter the echo data corresponding to the high reflectivity object and retain the echo data corresponding to the non-high reflectivity object.

In a specific application, the peak threshold and the width threshold can be set in advance. The LiDAR can compare the determined echo peak with the peak threshold and compare the determined echo width with the width threshold. If the echo peak is greater than or equal to the peak threshold and the echo width is greater than or equal to the width threshold, the echo can be determined as an echo corresponding to a high reflectivity object, and thus the echo can be filtered.

It should be noted that the echo waveform detected by the detection module 51 is different when the distance between the object and the LiDAR is different. For example, echo waveform 1 shown in FIG. 6 is an echo waveform corresponding to a close-range object, echo waveform 2 is an echo waveform corresponding to a medium-range object, and echo waveform 3 is an echo waveform corresponding to a long-range object. Therefore, to improve the detection accuracy of the echo corresponding to the high reflectivity object, different peak thresholds and different width thresholds can be set for different distances.

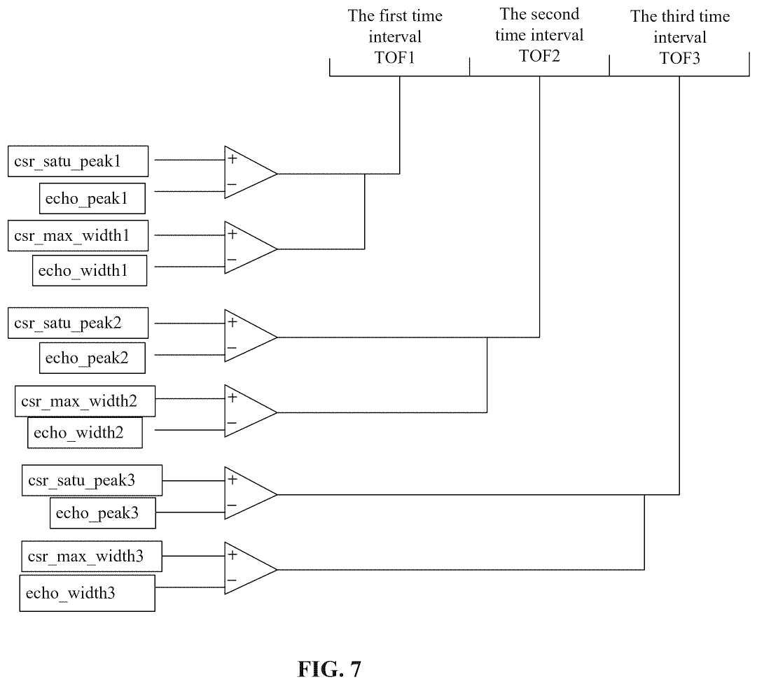

For example, referring to FIG. 7, which shows a process diagram of filtering the echo waveform corresponding to the high reflectivity object by the detection module 51, the entire receiving time is divided into three time intervals (corresponding to different distance values). The first time interval TOF1 is provided with a first peak threshold csr_satu_peak1 and a first width threshold csr_max_width1, the second time interval TOF2 is provided with a second peak threshold csr_satu_peak2 and a second width threshold csr_max_width2, and the third time interval TOF3 is provided with a third peak threshold csr_satu_peak3 and a third width threshold csr_max_width3.

For the echo in a different time interval, the corresponding threshold can be used to determine whether to filter the echo data corresponding to the echo.

For example, for the echo 1 in the first time interval, the peak echo_peak1 of the echo 1 can be compared with the first peak threshold csr_satu_peak1, and the echo width echo width of the echo 1 can be compared with the first width threshold csr_max_width1. If echo_peak1>=csr_satu_peak1 and echo_width1>=csr_max_width1, the echo data corresponding to the echo 1 is filtered out, otherwise the data of the echo 1 is retained.

For the echo 2 in the second time interval, the peak echo_peak2 of the echo 2 can be compared with the second peak threshold csr_satu_peak2, and the echo width echo_width2 of the echo 2 can be compared with the second width threshold csr_max_width2. If echo_peak2>=csr_satu_peak2 and echo_width2>=csr_max_width2, the echo data corresponding to the echo 2 is filtered out, otherwise the data of the echo 2 is retained.

For Echo 3 within the third time interval, the peak echo_peak2 of the echo 3 can be compared with the first peak threshold csr_satu_peak3, and the echo width echo_width3 of Echo 3 can be compared with the first width threshold csr_max_width3. If echo_peak3>=csr_satu_peak3 and echo_width3>=csr_max_width3, then filter out the corresponding echo data of Echo 3; otherwise the data of Echo 3 is retained.

It should be noted that the first peak threshold, the first width threshold, the second peak threshold, the second width threshold, the third peak threshold, and the third width threshold can be set according to actual application scenarios and actual measurement results. For example, in the scenario of measuring a close-range object, the first peak threshold, the first width threshold, the second peak threshold, the second width threshold, the third peak threshold, and the third width threshold can be all set as thresholds related to the echo characteristics of the close-range object, so that the echo data related to the close-range object that is not of interest can be filtered out, and the echo data related to the close-range object of interest can be retained. The setting of the first peak threshold, the first width threshold, the second peak threshold, the second width threshold, the third peak threshold, and the third width threshold can also be related to the parameters of the transmitter and the receiver. For example, if the transmission energy of the transmitter is large, the thresholds can be increased accordingly.

It should be noted that the above division of the entire receiving time into three time intervals is only an example of an implementation, and in other embodiments, the receiving time can also be divided into four time intervals, five time intervals, etc. The finer the receiving time is divided, the more accurate the echo filtering of the high reflectivity object is, but at the same time, more computing resources are required, so the number of receiving time division intervals can be set in combination with the measurement accuracy requirements and computing power level of the LiDAR.

In some embodiments of the present application, because the echo area of the echo of the high reflectivity object is very large, but the large echo area brought by the point cloud expansion does not have processing value, therefore, before the high reflection filtering is performed, the echo data can also be saturated and truncated based on the echo area, that is, a preset component bit width can be set, and the data greater than or equal to the preset component bit width is saturated and truncated by the preset component bit width. For example, the preset component bit width is 16 bits, and the data greater than or equal to 16 bits is saturated and truncated by ffff, and the echo data after the saturation and truncation is transmitted to a subsequent module for related high reflection filtering, thereby saving the calculation logic related to the echo area and saving the computing resources.

It should be noted that the subsequent module refers to a functional module in the LiDAR that processes the echo data, for example, the above detection module, the above limit filtering module, the above fusion processing module, the noise processing module, etc.

In an embodiment of the present application, the echo data can also be echo data received after the LiDAR performs transceiving control based on a preset scanning mode. The preset scanning mode refers to a scanning mode in which the LiDAR transmits a detection signal block by block, and a receiving unit group corresponding to the transmission block receives an echo signal, where the receiving unit group includes at least two receiving units.

In a specific application, the echo signal formed by the detection signal transmitted by one transmission block can be received by at least two receiving units at the same time, that is, the preset scanning mode sets a redundant receiving unit.

It should be noted that the redundancy of the receiving unit can set the number of redundant receiving units according to the distance deviation between the transmission laser in the transmission module and the receiving array in the receiving module and the angle of the transmission laser. For example, the offset of the received echo beam is determined according to the distance deviation between the transmission laser and the receiving array and the angle of the transmission laser, the greater the distance deviation between the transmitter and the receiver, the greater the offset of the target echo on the receiving array, and therefore the number of redundant receiving units can be greater.

When the detection signal detects a high reflectivity object, if only one receiving block is used to receive the echo signal, the received signal is likely to be covered by the echo signal reflected by the high reflectivity object, and after the redundant receiving unit is set, the redundant receiving unit has the opportunity to receive the echo signal reflected by other objects which is not covered by the echo reflected by the high reflectivity object, thereby improving the richness of the received echo signal, so that the LiDAR can use the one-time echo data with the least point cloud expansion in the subsequent steps to perform ranging and object recognition, thereby reducing the influence of the point cloud expansion phenomenon on the object recognition capability of the LiDAR.

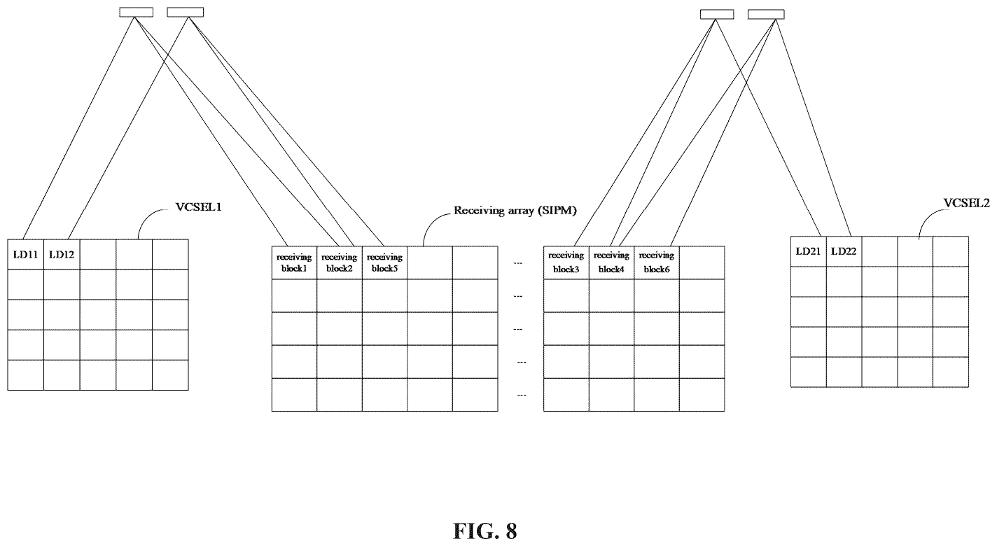

For example, referring to FIG. 8, which is a schematic diagram of a correspondence relationship between a transmitting module and a receiving module of a LiDAR provided by an embodiment of the present application. FIG. 8 illustrates an example in which the LiDAR includes two transmitters and one receiving SPAD array.

As shown in FIG. 8, the receiving unit group corresponding to the first transmitting block LD11 in the first transmitter VCSEL1 can include receiving block 1 and receiving block 2, and the receiving unit group corresponding to the first transmitting block LD21 in the second transmitter VCSEL2 can include receiving block 3 and receiving block 4. After the first transmitting block LD11 in the first transmitter VCSEL1 finishes transmitting, the LiDAR controls the second transmitting block LD12 in the first transmitter VCSEL to transmit a detection signal, at this time, receiving block 2 and receiving block 5 in the receiving array serve as the receiving unit group corresponding to the second transmitting block LD12 in the first transmitter VCSEL, and thus receive echo data.

Taking the correspondence relationship between the transmitting module and the receiving module shown in FIG. 8 as an example, the LiDAR scans according to the preset scanning mode, which can be as follows: the LiDAR controls the first transmitting block LD11 in the first transmitter VCSEL1 to transmit a detection signal (referred to as a first detection signal), and correspondingly controls receiving block 1 and receiving block 2 in the receiving SPAD array to receive echo signals corresponding to the first detection signal, at the same time, the first transmitting block LD21 in the second transmitter VCSEL2 can be controlled to transmit a detection signal (referred to as a second detection signal), and correspondingly receiving block 3 and receiving block 4 in the receiving SPAD array are controlled to receive echo signals corresponding to the second detection signal, after completion, the LiDAR can then control the second transmitting block LD12 in the first transmitter VCSEL1 to transmit a detection signal (referred to as a third detection signal), and correspondingly control receiving block 2 and receiving block 5 in the receiving SPAD array to receive echo signals corresponding to the third detection signal, control the second transmitting block LD22 in the second transmitter VCSEL2 to transmit a detection signal (referred to as a fourth detection signal), and correspondingly control receiving block 4 and receiving block 6 in the receiving SPAD array to receive echo signals corresponding to the fourth detection signal, and so on, until the transmission and reception of all blocks are completed.

It should be noted that FIG. 8 is only used as an example of a dual transmitter, and the LiDAR in the embodiment of the present application can also be a single transmitter or a multi-transmitter LiDAR, and the present application does not make specific limitations thereon.

As can be seen from the above, by acquiring the echo data received by the target receiving unit group with the redundant receiving units, and performing feature extraction based on the echo data, the high reflectivity echo can be identified and filtered, the point cloud corresponding to the point cloud expansion can be effectively filtered, the influence of the point cloud expansion on the object recognition capability of the LiDAR is reduced, and the object recognition accuracy of the LiDAR is improved.

In an embodiment of the present application, before S12, the method can further include: performing high-reflection filtering on the echo data according to the valid data interval.

In a specific application, the high-reflection filtering on the echo data according to the valid data interval can be performed by the limiting filtering module 52 in FIG. 5.

In a specific application, the echo signal corresponding to the detection signal emitted by the transmitter of the LiDAR is received by the receiving unit corresponding to the transmitting unit of the transmitter, and in some embodiments, the echo signal is received by the valid receiving interval in the receiving unit. For a high reflectivity object, the echo signal corresponding to the detection signal has large energy, so the received echo area is widened, and the valid receiving interval is unchanged, so the echo larger than or equal to the valid receiving area can be considered as an invalid echo caused by the point cloud expansion, and the echo can be filtered.

It should be noted that the receiving module (for example, a receiving surface array) can include a plurality of receiving units (or receiving blocks), and each receiving block can include a plurality of receiving pixels, that is, the receiving pixels are smaller receiving units in the receiving block. For example, one receiving block can include 8*4 receiving pixels, and after the transmitter of the transmitting module emits the detection signal, the receiving pixels in the valid receiving interval in the receiving block in the receiving array can receive the echo signal.

In an embodiment of the present application, the high-reflection filtering on the echo data according to the valid data interval can include the following steps:
determining, from the valid receiving interval table, a receiving pixel range of the valid receiving interval according to the distance value corresponding to the echo data and the transmitting block position of the LiDAR;
if the receiving range of the echo exceeds the receiving pixel range of the valid receiving interval, outputting the echo data in the valid receiving interval;
if the receiving range of the echo is within the receiving pixel range of the valid receiving interval, outputting all the echo data.

In a specific application, the valid receiving interval table can be determined by actual measurement in advance, and each LiDAR can be correspondingly provided with a valid receiving interval table, and the receiving pixel range of the valid receiving interval corresponding to the transmitter position and different scanning distances is determined by calibration testing.

That is, the transmitter of the radar and the scanning distance can be used as indexes to determine the receiving pixel range of the effective receiving interval corresponding to the current transmitter and the scanning distance from the effective receiving interval table.

Then, the receiving range of the echo is compared with the receiving pixel range of the effective receiving interval. Assuming that the receiving pixel range of the effective receiving interval is [pix_num_min, pix_num_max], if the receiving range of the current echo is less than pix_num_min or greater than pix_num_max, it is determined that the receiving range of the echo exceeds the receiving pixel range of the effective receiving interval, otherwise, it is determined that the receiving range of the echo is within the receiving pixel range of the effective receiving interval.

In a specific application, the effective receiving interval table can include table entries corresponding to different distance gears. For example, assuming that 64 gears are used for the distance range, 64 table entries are required for each transmitting block, and the indexes are the transmitting block position number and the distance value corresponding to the echo.

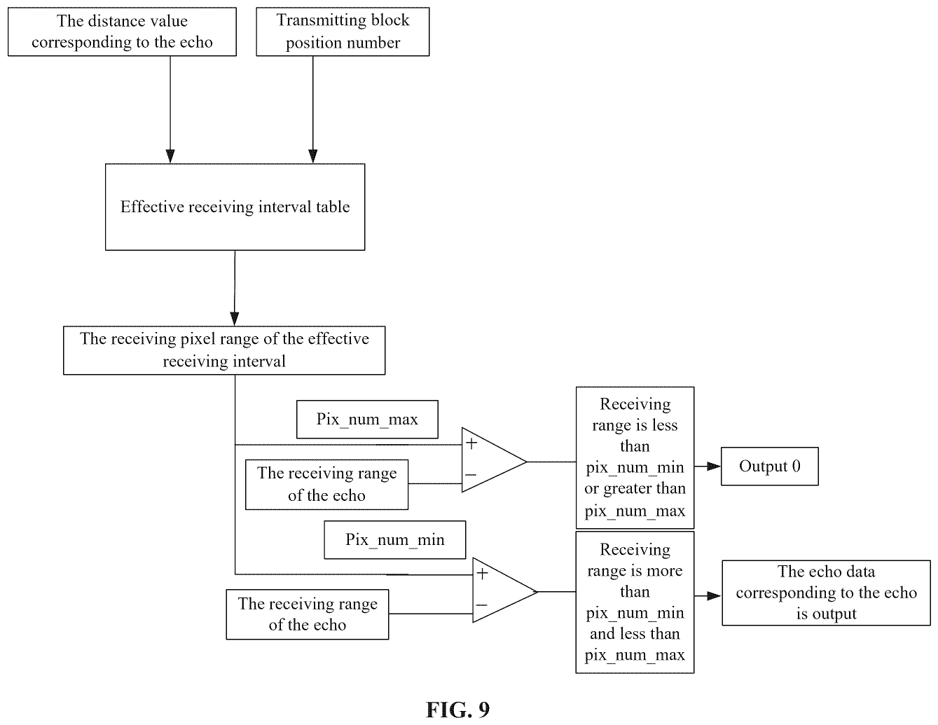

For example, referring to FIG. 9, which shows a schematic diagram of the limiting filtering process, after the distance value corresponding to the echo and the transmitting block position number are input, the distance gear where the distance value corresponding to the echo is located can be determined, and then the effective receiving interval table is searched according to the distance gear and the transmitting block position number to determine the receiving pixel range of the effective receiving interval, including the upper limit value pix_num_max and the lower limit value pix_num_min. It is determined whether the receiving range of the echo is less than the lower limit value pix_num_min and whether the receiving range of the echo is greater than the upper limit value pix_num_max. If the receiving range is less than pix_num_min or greater than pix_num_max, 0 is output, otherwise, the echo data corresponding to the echo is output.

As can be seen, the echo data processing method provided by the embodiment of the present application can obtain the echo data received by the target receiving unit group with the redundant receiving units, perform feature extraction based on the echo data, and perform identification and filtering of the high reflectivity echo in the limiting filtering process, thereby effectively filtering the point cloud corresponding to the point cloud expansion, reducing the influence of the point cloud expansion on the object recognition capability of the LiDAR, and improving the object recognition accuracy of the LiDAR.

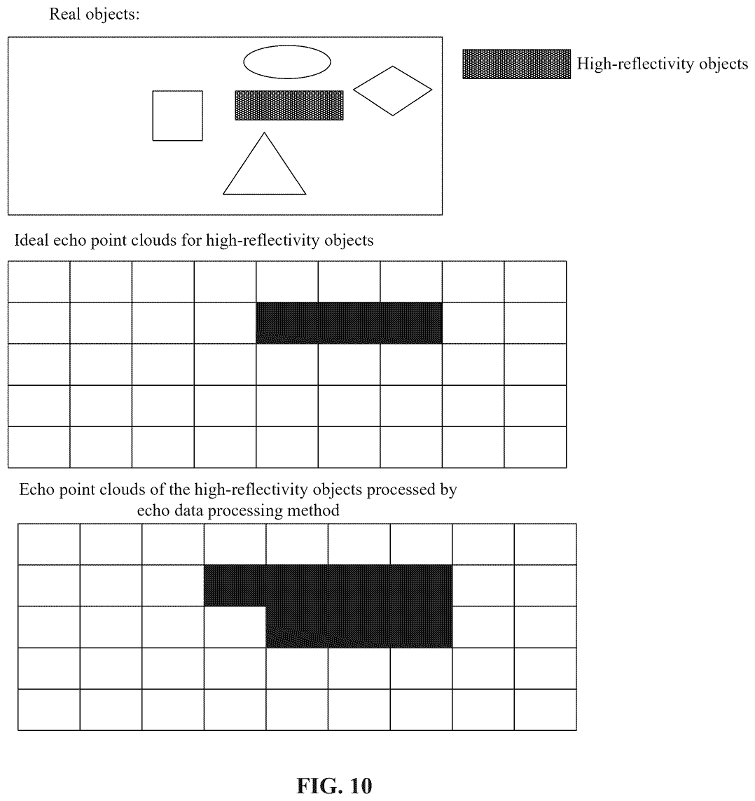

FIG. 10 shows the distribution of the point cloud data after the echo data processing method provided by the embodiment of the present application is processed. As can be seen from FIG. 10, the echo data processing method provided by the embodiment of the present application can better suppress the phenomenon of point cloud expansion caused by the high reflectivity object.

It should be noted that the point cloud data after being processed by the echo data processing method can be stored in the storage module 54.

It should be understood that the sequence numbers of the steps in the above embodiments do not mean the execution sequence, and the execution sequence of each process should be determined according to its function and inherent logic, and should not constitute any limitation on the implementation of the present application.

Based on the echo data processing method above, the present application further provides an echo data processing device for implementing the echo data processing method.

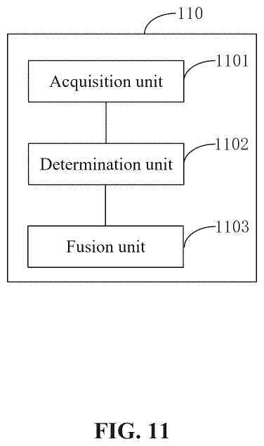

FIG. 11 is a schematic structural diagram of an echo data processing device provided by an embodiment of the present application. The echo data processing device includes units for performing the steps in the corresponding embodiment of FIG. 3. For details, refer to FIG. 3 and related description. For ease of description, only parts related to the embodiment are shown. As shown in FIG. 11, the echo data processing device 110 can include an acquisition unit 1101, a determination unit 1102, and a fusion unit 1103.

The acquisition unit 1101 is configured to acquire echo data corresponding to multiple scans, and determine echo features according to the echo data.

The determination unit 1102 is configured to determine target echo data according to the echo features of the current scan and the echo features of the last scan; the target echo data is echo data after high-reflection expansion echo is filtered out.

The fusion unit 1103 is configured to fuse the target echo data, so as to perform target recognition according to the fused target echo data.

In some implementations, the echo features include an echo area, and the determination unit is configured to: if there is a high-reflection expansion echo in the echo of the current scan or the echo of the last scan, take echo data with a small echo area as the target echo data; if there is no high-reflection expansion echo in the echo of the current scan or the echo of the last scan, take echo data with a large echo area as the target echo data; and if an absolute value difference between the echo area of the current scan and the echo area of the last scan is less than a preset area difference threshold, or an absolute value difference between a distance value corresponding to the echo of the current scan and a distance value corresponding to the echo of the last scan is less than a distance difference threshold, take an average of the echo data of the current scan and the echo data of the last scan as the target echo data.

In some implementations, the echo features are affected by transmission power, and the determination unit is configured to: if there is a high-reflection expansion echo in the echo of the current scan or the echo of the last scan, determine echo data corresponding to a scan with small transmission power as the target echo data;
if there is no high-reflection expansion echo in the echo of the current scan or the echo of the last scan, determine echo data corresponding to a scan with large transmission power as the target echo data;
if an absolute value difference between the transmission power of the current scan and the transmission power of the last scan is less than a preset power difference threshold, or an absolute value difference between a distance value corresponding to the echo of the current scan and a distance value corresponding to the echo of the last scan is less than a distance difference threshold, take an average of the echo data of the current scan and the echo data of the last scan as the target echo data.

In some implementations, the echo data processing device 110 can further include a detection filtering unit.

The detection filtering unit is configured to determine an echo peak value and an echo width of each echo according to the detection result; determine that the echo is an echo corresponding to a high reflectivity object if the echo peak value of the echo is greater than or equal to a peak threshold and the echo width of the echo is greater than or equal to a width threshold; and filter echo data corresponding to the high reflectivity object from the echo data to obtain echo data after detection filtering.

In some implementations, the detection filtering unit is configured to determine the peak threshold and the width threshold for a time interval in which the echo is located, where different time intervals are set with different peak thresholds and width thresholds. The echo is determined as an echo corresponding to a high reflectivity object if the echo peak value of the echo is greater than or equal to the peak threshold corresponding to the time interval in which the echo is located and the echo width of the echo is greater than or equal to the width threshold corresponding to the time interval in which the echo is located.

In some implementations, the echo data processing device 110 can further include a range filtering unit.

The range filtering unit is configured to perform high-frequency filtering on the echo data according to the valid data interval. In some implementations, the range filtering unit is configured to determine a receiving pixel range of the valid receiving interval from a valid receiving interval table according to a distance value corresponding to the echo and a transmitting block position of the LiDAR; output corresponding echo data in the valid receiving interval if a receiving range of the echo is beyond the receiving pixel range of the valid receiving interval; and output all echo data if the receiving range of the echo is within the receiving pixel range of the valid receiving interval.

The echo data processing apparatus can further include a saturation clipping unit configured to perform saturation clipping on the echo data based on an echo area of the echo. It should be noted that the information interaction and execution process between the units are based on the same concept as the method embodiments, and the specific functions and technical effects thereof can be referred to the method embodiments, and will not be described herein.

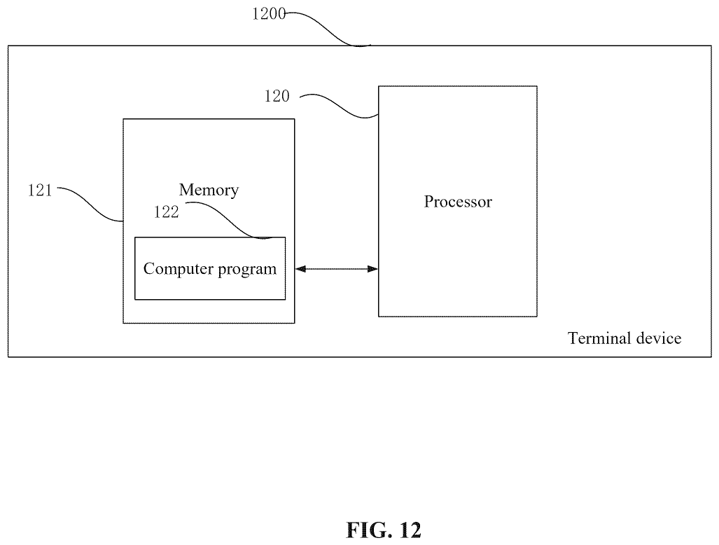

FIG. 12 is a schematic diagram of a structure of a terminal device provided by another embodiment of the present application. As shown in FIG. 12, the terminal device 1200 includes a processor 120, a memory 121, and a computer program 122 stored in the memory 121 and executable on the processor 120, for example, an image segmentation program. The processor 120 implements the steps in the echo data processing method embodiments when executing the computer program 122, for example, S11-S12 shown in FIG. 3. In some embodiments, the processor 120 implements the functions of the modules/units in the terminal device embodiments when executing the computer program 122, for example, the functions of the units 1101-1102 shown in FIG. 11.

The computer program 122 can be divided into one or more modules/units, which are stored in the memory 121 and executed by the processor 120 to complete the present application. The one or more modules/units can be a series of computer program instruction segments capable of completing specific functions, and the instruction segments are used to describe the execution process of the computer program 122 in the terminal device 1200. For example, the computer program 122 can be divided into an obtaining unit, a determining unit, and a calculating unit, and the specific functions of the units can be referred to the related description in the corresponding embodiments in FIG. 7, and details are not described herein.

The terminal device can include but is not limited to the processor 120 and the memory 121. It can be understood by those skilled in the art that FIG. 12 is merely an example of the terminal device 1200, and does not constitute a limitation on the terminal device 1200, and can include more or less components than the illustration, or combine certain components, or different components, for example, the terminal device can also include an input/output device, a network access device, a bus, and the like.

The processor 120 can be a central processing unit (CPU), and can also be other general-purpose processors, a digital signal processor (DSP), an application specific integrated circuit (ASIC), a field-programmable gate array (FPGA) or other programmable logic device, discrete gate or transistor logic device, discrete hardware component, or the like. The general-purpose processor can be a microprocessor, or the processor can also be any conventional processor, or the like.

The memory 121 can be an internal storage unit of the terminal device 1200, for example, a hard disk or a memory of the terminal device 1200. The memory 121 can also be an external storage device of the terminal device 1200, for example, a plug-in hard disk, a smart media card (SMC), a secure digital (SD) card, a flash card, or the like, which is equipped on the terminal device 1200. Further, the memory 121 can include both the internal storage unit and the external storage device of the terminal device 1200. The memory 121 is used for storing the computer program and other programs and data required by the terminal device. The memory 121 can also be used for temporarily storing data that has been output or is to be output.

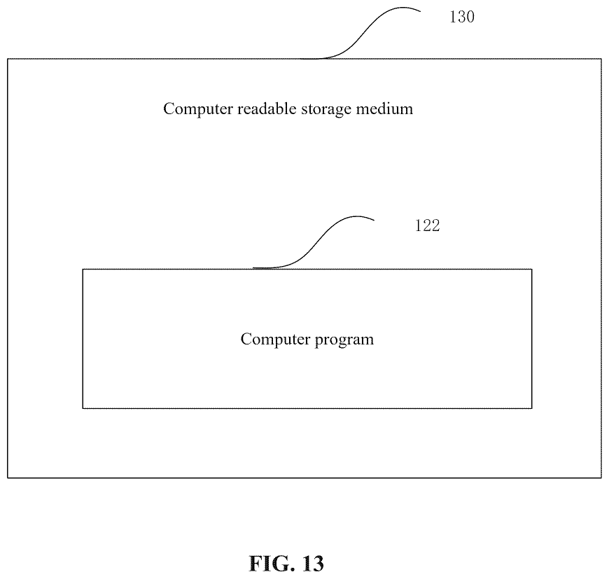

The present application further provides a computer readable storage medium. Referring to FIG. 13, which is a structural schematic diagram of a computer readable storage medium provided by the present application. As shown in FIG. 13, the computer readable storage medium 130 stores a computer program 122. When the computer program 122 is executed by a processor, the echo data processing method can be implemented.

The present application further provides a computer program product. When the computer program product is run on a terminal device, the terminal device is enabled to implement the echo data processing method.

Those skilled in the art can understand that, for the convenience and brevity of description, only the division of the above functional units and modules is exemplified, and in actual application, the above functions can be distributed to different functional units and modules according to requirements, that is, the internal structure of the terminal device is divided into different functional units or modules to complete all or part of the functions described above. Each functional unit and module can be integrated in one processing unit, or each unit can be physically present separately, or two or more units can be integrated in one unit. The integrated unit can be implemented in the form of hardware, or in the form of a software functional unit. In addition, the specific names of the functional units and modules are only for convenient mutual distinction, and are not used to limit the protection scope of the present application. The specific working processes of the units and modules in the system can refer to the corresponding processes in the foregoing method embodiments, and will not be described herein.

In the above embodiments, the description of each embodiment has its own focus, and the parts not detailed or described in a certain embodiment can be referred to the related description of other embodiments.

A person of ordinary skill in the art can be aware that, in combination with the examples described in the present application, units and algorithm steps can be implemented by electronic hardware, or a combination of computer software and electronic hardware. Whether the functions are performed by hardware or software depends on particular applications and design constraints of the technical solutions. A person skilled in the art can use different methods to implement the described functions for each particular application, but it should not be considered that such implementation goes beyond the scope of the present application.

The above embodiments are only used to illustrate the technical solutions of the present application, but not to limit them; although the present application is described in detail with reference to the foregoing embodiments, a person of ordinary skill in the art should understand that the technical solutions recorded in the foregoing embodiments can still be modified, or some technical features can be replaced by equivalents; and these modifications or replacements do not make the essence of the corresponding technical solutions deviate from the spirit and scope of the technical solutions of the embodiments of the present application, and should be included in the protection scope of the present application.

What is claimed is:

1. An echo data processing method, comprising:
obtaining echo data corresponding to a plurality of scans, and determining echo features according to the echo data;
determining target echo data according to the echo features of a current scan and the echo features of a last scan, the target echo data being echo data after high-reflection-expansion echo is filtered out; and
fusing the target echo data to perform target recognition according to the fused target echo data.

2. The echo data processing method according to claim 1, wherein the echo features comprise echo areas, and the determining of the target echo data according to the echo features of the current scan and the echo features of the last scan comprises:
in response to the existence of high-reflection-expansion echo in the echo of the current scan or the echo of the last scan, determining the echo data corresponding to the scan with a smaller echo area as the target echo data;
in response to the non-existence of high-reflection-expansion echo in the echo of the current scan or the echo of the last scan, determining the echo data corresponding to the scan with a larger echo area as the target echo data; and
in response to an absolute value difference between the echo area of the current scan and the echo area of the last scan being less than a preset area difference threshold, or an absolute value difference between a distance value corresponding to the echo of the current scan and a distance value corresponding to the echo of the last scan being less than a distance difference threshold, taking an average value of the echo data of the current scan and the echo data of the last scan as the target echo data.

3. The echo data processing method according to claim 1, wherein the echo features comprise transmission power, and the determining of the target echo data according to the echo features of the current scan and the echo features of the last scan comprises:
in response to the existence of high-reflection-expansion echo in the echo of the current scan or the echo of the last scan, determining the echo data corresponding to the scan with smaller transmission power as the target echo data;
in response to the non-existence of high-reflection-expansion echo in the echo of the current scan or the echo of the last scan, determining the echo data corresponding to the scan with larger transmission power as the target echo data; and
in response to an absolute value difference between the transmission power of the current scan and the transmission power of the last scan being less than a preset power difference threshold, or an absolute value difference between a distance value corresponding to the echo of the current scan and a distance value corresponding to the echo of the last scan being less than a distance difference threshold, taking an average value of the echo data of the current scan and the echo data of the last scan as the target echo data.

4. The echo data processing method according to claim 1, wherein before the determining of the target echo data according to the echo features of the current scan and the echo features of the last scan, the method further comprises:
determining an echo peak value and an echo width of each echo according to a detection result;
in response to the echo peak value of the echo being greater than or equal to a peak threshold and the echo width of the echo being greater than or equal to a width threshold, determining that the echo is an echo corresponding to a high-reflectivity object; and
filtering out the echo data corresponding to the high reflectivity object from the echo data to obtain echo data after detection filtering.

5. The echo data processing method according to claim 4, wherein after the determining the echo peak value and the echo width of each echo according to the detection result, the method further comprises:
determining the peak threshold and the width threshold of a time interval where the echo is located, wherein different time intervals are set with different peak thresholds and width thresholds; and
in response to the echo peak value of the echo being greater than or equal to the peak threshold corresponding to the time interval where the echo is located, and the echo width of the echo being greater than or equal to the width threshold corresponding to the time interval where the echo is located, determining that the echo is the echo corresponding to the high reflectivity object.

6. The echo data processing method according to claim 1, wherein the echo data is received by a LiDAR after the LiDAR performs transmitting and receiving control based on a preset scanning mode, the preset scanning mode is a scanning mode in which the LiDAR transmits detection signals block by block by a laser emitter of the LiDAR, and the echo signal is received by a receiving unit group corresponding to the transmitting block, wherein the receiving unit group includes at least two receiving units.

7. The echo data processing method according to claim 6, wherein before the determining the target echo data according to the echo feature of the current scanning and the echo feature of the last scanning, the method further comprises:
performing high reflection filtering on the echo data according to a valid data interval.

8. The echo data processing method according to claim 7, wherein the performing high reflection filtering on the echo data according to the valid data interval comprises:
determining, from a valid receiving interval table, a receiving pixel range of a valid receiving interval according to a distance value corresponding to the echo and the transmitting block position of the LiDAR;
in response to the receiving range of the echo exceeding the receiving pixel range of the valid receiving interval, outputting the echo data corresponding to the valid receiving interval; and
in response to the receiving range of the echo being within the receiving pixel range of the valid receiving interval, outputting all the echo data.

9. A terminal device, comprising a memory, a processor, and a computer program stored in the memory, wherein when the computer program is executed by the processor, the computer program causes the processor to implement operations comprising:
obtaining echo data corresponding to a plurality of scans, and determining echo features according to the echo data;
determining target echo data according to the echo features of a current scan and the echo features of a last scan, the target echo data being echo data after high-reflection-expansion echo is filtered out; and
fusing the target echo data to perform target recognition according to the fused target echo data.

10. The terminal device according to claim 9, wherein the echo features comprise echo areas, and the determining of the target echo data according to the echo features of the current scan and the echo features of the last scan comprises:
in response to the existence of high-reflection-expansion echo in the echo of the current scan or the echo of the last scan, determining the echo data corresponding to the scan with a smaller echo area as the target echo data;
in response to the non-existence of high-reflection-expansion echo in the echo of the current scan or the echo of the last scan, determining the echo data corresponding to the scan with a larger echo area as the target echo data; and
in response to an absolute value difference between the echo area of the current scan and the echo area of the last scan being less than a preset area difference threshold, or an absolute value difference between a distance value corresponding to the echo of the current scan and a distance value corresponding to the echo of the last scan being less than a distance difference threshold, taking an average value of the echo data of the current scan and the echo data of the last scan as the target echo data.

11. The terminal device according to claim 9, wherein the echo features comprise transmission power, and the determining of the target echo data according to the echo features of the current scan and the echo features of the last scan comprises:
in response to the existence of high-reflection-expansion echo in the echo of the current scan or the echo of the last scan, determining the echo data corresponding to the scan with smaller transmission power as the target echo data;
in response to the non-existence of high-reflection-expansion echo in the echo of the current scan or the echo of the last scan, determining the echo data corresponding to the scan with larger transmission power as the target echo data; and
in response to an absolute value difference between the transmission power of the current scan and the transmission power of the last scan being less than a preset power difference threshold, or an absolute value difference between a distance value corresponding to the echo of the current scan and a distance value corresponding to the echo of the last scan being less than a distance difference threshold, taking an average value of the echo data of the current scan and the echo data of the last scan as the target echo data.

12. The terminal device according to claim 9, wherein before the determining of the target echo data according to the echo features of the current scan and the echo features of the last scan, the operations further comprise:
determining an echo peak value and an echo width of each echo according to a detection result;
in response to the echo peak value of the echo being greater than or equal to a peak threshold and the echo width of the echo being greater than or equal to a width threshold, determining that the echo is an echo corresponding to a high-reflectivity object; and
filtering out the echo data corresponding to the high reflectivity object from the echo data to obtain echo data after detection filtering.

13. The terminal device according to claim 12, wherein after the determining the echo peak value and the echo width of each echo according to the detection result, the operations further comprise:
determining the peak threshold and the width threshold of a time interval where the echo is located, wherein different time intervals are set with different peak thresholds and width thresholds; and
in response to the echo peak value of the echo being greater than or equal to the peak threshold corresponding to the time interval where the echo is located, and the echo width of the echo being greater than or equal to the width threshold corresponding to the time interval where the echo is located, determining that the echo is the echo corresponding to the high reflectivity object.

14. The terminal device according to claim 9, wherein the echo data is received by a LiDAR after the LiDAR performs transmitting and receiving control based on a preset scanning mode, the preset scanning mode is a scanning mode in which the LiDAR transmits detection signals block by block by a laser emitter of the LiDAR, and the echo signal is received by a receiving unit group corresponding to the transmitting block, wherein the receiving unit group includes at least two receiving units.

15. The terminal device according to claim 14, wherein before the determining the target echo data according to the echo feature of the current scanning and the echo feature of the last scanning, the operations further comprise:
performing high reflection filtering on the echo data according to a valid data interval.

16. The terminal device according to claim 15, wherein the performing high reflection filtering on the echo data according to the valid data interval comprises:
determining, from a valid receiving interval table, a receiving pixel range of a valid receiving interval according to a distance value corresponding to the echo and the transmitting block position of the LiDAR;
in response to the receiving range of the echo exceeding the receiving pixel range of the valid receiving interval, outputting the echo data corresponding to the valid receiving interval; and
in response to the receiving range of the echo being within the receiving pixel range of the valid receiving interval, outputting all the echo data.

17. A non-transitory computer-readable storage medium storing a computer program, wherein when the computer program is executed by a processor, the computer program causes the processor to implement operations comprising:
obtaining echo data corresponding to a plurality of scans, and determining echo features according to the echo data;
determining target echo data according to the echo features of a current scan and the echo features of a last scan, the target echo data being echo data after high-reflection-expansion echo is filtered out; and
fusing the target echo data to perform target recognition according to the fused target echo data.
